(19) United States
(12) Patent Application Publication
(10) Pub. No.: US 2008/0072661 A1
(43) Pub. Date: Mar. 27, 2008

(54) Bottle finish scoring head and method

(75) Inventors: Donald Prestley, (US); Dennis Broeske, (US)

Correspondence Address: PEPSICO, INC.;c/o Banner Witcoff Ltd, 10 South Wacker Drive, Suite 3000, Chicago, IL, 60606-7407, US

(73) Assignee: Stokely-Van Camp, Inc., Chicago, IL (US)

(21) Appl. No.: 11/512,833

(22) Filed: Aug. 29, 2006

(51) Int. Cl. F16J 9/00

(52) U.S. Cl. 73/52; 215/40; 277/320; 29/76.1

(57) ABSTRACT

An apparatus for use in the production of a test specimen bottle from a container which is adaptable for containing a liquid and has a sealing surface intended for mating with a sealing closure. The test specimen bottle is utilized in a test for evaluating the integrity of a sealing closure. The apparatus comprises a scoring head which has a body and at least one blade mounted to the body. The body includes mounting structure associated with the body for connecting the body to a force applying mechanism for transmitting force to the body so that when the blade mounted to the body is positioned adjacent to the sealing surface of the container, a force can be applied to the body that causes the blade to score the sealing surface to thereby produce a test specimen bottle from the container.

### BACKGROUND OF THE INVENTION

1. Field of the Invention

The invention relates generally to an apparatus and method for preparing a test specimen for use in a test for evaluating the integrity of a seal of a plastic bottle and a closure cap.

2. Description of the Related Art

Containers with sealing closures have long been in wide spread use throughout the food and beverage industry. The closures are designed to prevent leakage of the contents while still being able to be easily removed by the consumer. Another function of many such closures is that they need to be designed to allow resealing of the container after a portion of the contents have been dispensed, so as to allow continued storing of the remaining contents for later use.

Due to sanitary and health concerns, when a sealing closure fails and leakage occurs, the contents and container must be discarded. If a failure occurs prior to the sale of the container, the manufacturer loses all economic benefit of the cost of production of the contents, the cost of the bottle, the cost of the closure, as well as labeling and shipping costs. Moreover, a failure can reduce the manufacturer's good will with a wholesale distributor, a retail seller or a consumer.

In the production and procuring of plastic bottles it is common to have a broad variation in the quality of the sealing surfaces of the containers. The typical inconsistencies in the quality of the sealing surface of the bottles, however, do not necessarily lead to a problem of leakage and failure if the bottle closure quality is within an acceptable range of tolerance. This is because if the closure cap utilized with the bottle has been produced with a quality within a normal range of tolerance for the closure, such closure will effectively seal a plastic bottle which has customary minor defects. These typical imperfections of the sealing surfaces are generally attributable to processing conditions such as heat exposure, finish abrasions, fill temperature, head space pull-up range, inversion and abrasion arising during shipping and handling. Thus, the manufacturer has a choice. It can increase manufacturing costs to provide a bottle with a higher quality sealing surface, or it can control the quality of the closures so that the manufacturer is confident that the bottle and closure combination will not fail under normal use. The latter choice is more economically advantageous for the manufacturer.

Tests for determining the integrity of a seal of a plastic container are known, including, for example, tests disclosed in U.S. Pat. No. 6,807,846 to Leonard, et al. and U.S. Pat. No. 6,526,810 to Konieczki. In some applications of such tests it is desirable that the bottles used in testing the seal do not vary in their range of quality. Also, in certain tests it is advantageous to test bottles that do not include those which have a very high quality sealing surface. If a poorer quality closure is mated with a bottle with a high quality sealing surface, the closure may pass the test even though the closure would have failed if it had been mated with a container having a relatively poor sealing surface, such as in the lower end of the range of acceptable bottle finish tolerances.

It would be desirable to utilize a sample bottle specimen that has a bottle sealing surface having a relatively high level of defects. Such bottle may even be outside the acceptable range of defects or finish tolerances for the sealing surface. In other words, in a closure cap quality control test, the purpose is not to determine if closure will work with the best quality bottles, but whether it will effectively seal bottles having relatively low quality sealing surfaces, i.e., at the low end of the quality range, or even outside of acceptable bottle sealing surface tolerances.

A need exists for an apparatus and method which can be used to produce a test specimen bottle of a consistent predetermined level of defects in the sealing surface of the bottle for the purpose of performing a quality control seal integrity test for bottle closures.

### BRIEF SUMMARY OF THE INVENTION

The present invention addresses the foregoing needs by providing an apparatus and method of producing test specimen bottles with a predetermined and consistent level of defects for use in quality control tests of closures used with a particular type of bottle.

A first aspect of the present invention is an apparatus for use in the production of a test specimen from a container which is adaptable for containing a liquid and has a sealing surface intended for mating with a sealing closure. The test specimen bottle may then be utilized in a test evaluating the integrity of a sealing closure. The apparatus comprises a scoring head which has a body and at least one blade mounted to the body. The body includes a mounting structure associated with the body for connecting the body to a force applying mechanism for transmitting force to the body. When the blade mounted to the body is positioned adjacent to the sealing surface of the container, a force is applied to the body to cause the blade to score the sealing surface to thereby produce a test specimen from the container.

A second aspect of the present invention is an apparatus for the production of a test control bottle from a plastic bottle having a sealing surface on the bottle which is adaptable for mating with a sealing closure to seal to the interior of said bottle. The test control bottle has a sealing surface which is deformed with a predetermined level of deformation which is advantageous for use in a test for the evaluation of the integrity of the seal provided by a closure when applied to the test control bottle. The apparatus comprises a scoring head having a body with at least one blade mounted to the body. The body has a mounting surface for mounting the body to a force transmitting mechanism for applying a force to the body to cause the blade to deform a container positioned adjacent the blade to thereby produce the test control bottle.

A third aspect of the present invention is a method of producing test control bottles which have a consistently deformed sealing surface for later use in a quality control test of a closure mated to the deformed sealing surface. The method includes providing a bottle with a sealing surface, providing an apparatus which includes a scoring head which has mounted thereon a plurality of blades, positioning the bottle in operative alignment with the apparatus, causing relative movement between the scoring head and the bottle to cause the blades to contact the sealing surface, and continuing the relative movement to continue to move the scoring head blades into the sealing surface to deform the sealing surface by scoring the sealing surface of the bottle to thereby produce a test control bottle.

These, and other objects, features, and advantages of this invention will become apparent from the following detailed description of the illustrative embodiments thereof, which are to be read in connection with the accompanying drawings.

### BRIEF DESCRIPTION OF THE DRAWINGS

FIG. 1 is a side plan view showing an apparatus for producing test specimen bottles formed in accordance with the present invention, and shows in dotted lines the initial position of a scoring head prior to movement to contact the bottle.

FIG. 2 is a bottom perspective view of the scoring head device;

FIG. 3 is a side plan view of the scoring head body and shaft;

FIG. 4 is a bottom view of the scoring head device;

FIG. 5 is a top perspective view of the top plate of the support; and

FIG. 6 is a perspective view of a test specimen control body showing the scores produced in the sealing surface of the bottle by the scoring head device.

### DETAILED DESCRIPTION OF THE INVENTION

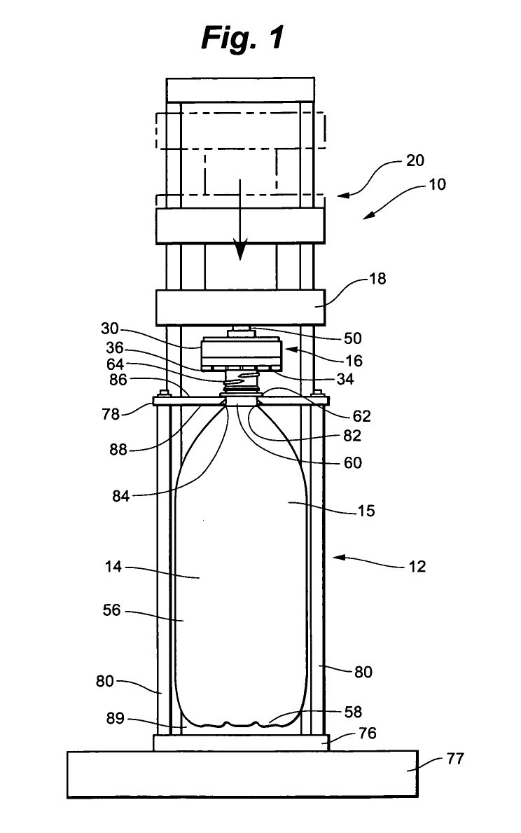

As shown in FIG. 1, the present invention provides an apparatus 10 for producing control test specimen containers for later use in a test for evaluating the seal of a closure. Apparatus 10 includes a support 12 for holding a bottle 14 from which the test specimen 15 is to be produced, a scoring head apparatus 16, and a ram 18 connected to the scoring head apparatus 16. Ram 18 is connected to a force generating machine or press 20 for reciprocally moving scoring head 16 into engagement with bottle 14, and thereafter applying a predetermined force to score the top rim sealing surface 22 of bottle 14 to produce a test specimen bottle.

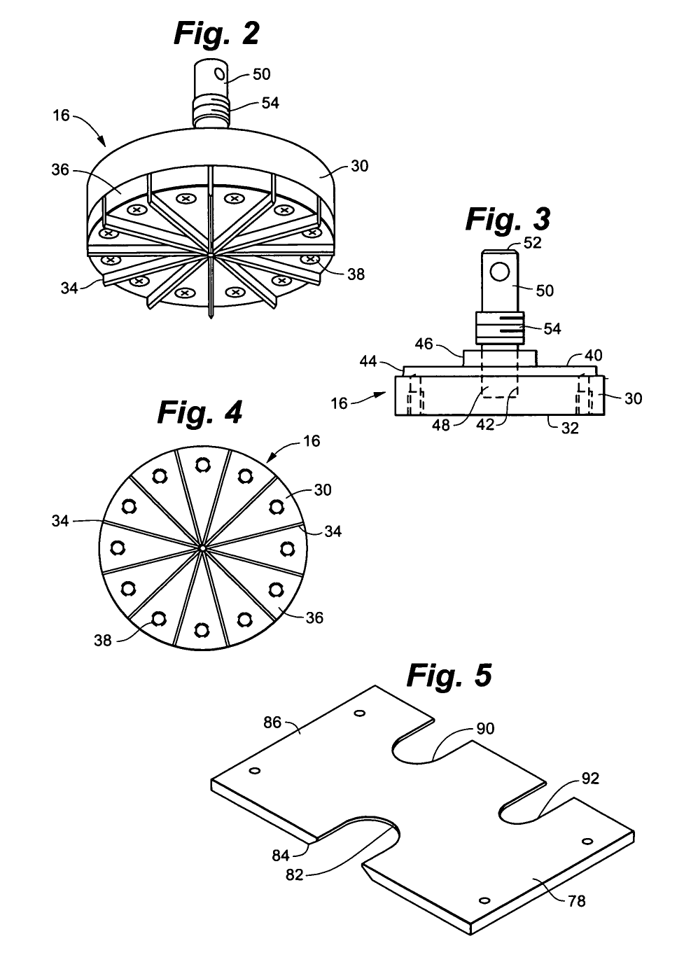

As best seen in FIGS. 2-4, scoring head 16 has a body 30 with a bottom side 32. Bottom side 32 has a plurality of knife or scoring blades 34 radially extending from the center of body 30 and preferably positioned in an evenly spaced relationship around bottom side 32 of scoring head 16. For example, as shown in FIG. 4, scoring head 16 has twelve blades 34 positioned approximately every 30° about scoring head 16. Blades 34 are preferably secured to side 32 by a plurality of wedge shaped segments 36 which are removably secured to body 30 by any suitable means, such as by screws 38. Blades 34 are then positioned between segments 36 and wedged there between by the side surfaces of adjacent wedge segments 36 to thereby grip at least a portion of the sides of a blade 34. Blades 34 are readily replaceable, when required, preferably by removal of wedge segments 36 to allow removal of old blades 34 and insertion of new blades 34. The thickness of the cutting edge of blades 34 preferably is in the range 0.015 to 0.020 inches. For example, 9 mm snap-off blades manufactured by The Stanley Works, 1000 Stanley Drive, New Britain, Conn. 0653 having a part number of 11-300 and having a blade thickness of 0.017 inches are suitable for use in the present invention.

The top side 40 of scoring head body 30 includes an axially centered bore 42. Bore 42 is surrounded by support reinforcement surfaces 44 and 46 appearing on top side 40 of scoring head body 30. One end 48 of shaft 50 is preferably force fitted within bore 42. The top end 52 of shaft 50 is coupled to ram 18 and secured thereto, for example, by threads 54 on shaft 50.

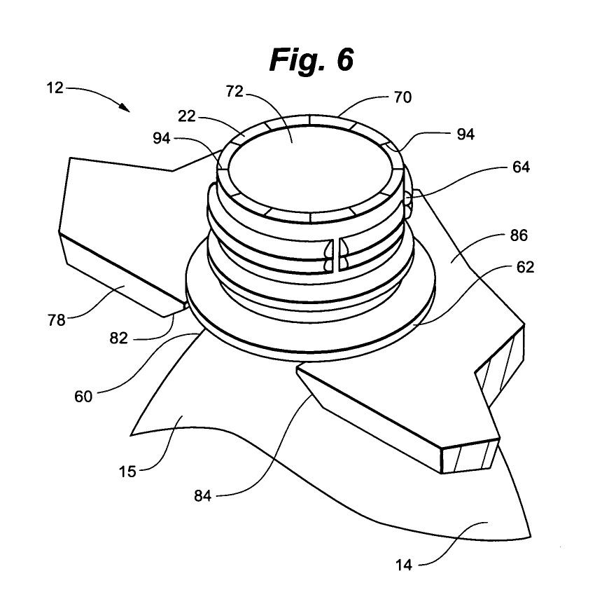

To produce a test specimen, a plastic bottle 14 is randomly selected from a plastic bottle production line. Referring again to FIG. 1, bottle 14 can be of any one of the many types of plastic bottles, including but not limited to 12 oz. bottles, 20 oz. bottles and 2 liter beverage bottles. These bottles normally include a sidewall 56, closed bottom end 58 and a reduced diameter neck 60. Neck 60 includes ring 62 and threads 64 for receiving a bottle cap closure (not shown). As best seen in FIG. 6, at the top of bottle 14 is rim 70 defining opening 72. On the top of rim 70 is top surface 22 which provides the primary sealing surface on the bottle for mating with a closure, which typically may include an inner seal membrane insert which abuts rim surface 22 when the closure is tightened to bottle 14 on threads 64.

Referring to FIG. 1 and FIG. 5, bottle support 12 has a base 76 positioned on table 77 of press 20, and has a top support plate 78 supported by columns 80. Top support member 78 has a recess, which is preferably a generally “U” shaped recess 82, along one edge of plate 78. Recess 82 is formed with an inner wall 84 which slopes inwardly from the top surface 86 of top support plate 78 to the bottom surface 88 of top plate 78.

In operation, bottle 14 is inserted into recess 82 with bottle ring 62 resting on the top surface 86 of support plate 78. It is noted that the height of columns 80 exceeds the height of a bottle to be modified by the present invention as measured from the bottom of the bottom wall 58 to the bottom of ring 62. Thus, when bottle 14 is positioned within support 12, a gap 89 will advantageously appear between bottle bottom 58 and support base 76. This results in bottle 14 being supported in the axial direction only on ring 62 and by top surface 86 of support plate 78 adjacent recess 82. It is noted that for smaller sized bottles having a ring 62 of a lesser diameter, narrower recesses 90 and 92 are provided in top plate 78. Thus, a smaller bottle will be supported in the appropriate narrower recess when producing test specimens from such smaller bottles.

Support 12 is positioned on table 77 so that bottle 14 is in axially alignment with scoring head 16, and thus when head 16 is advanced, blades 34 contact the top sealing surface 22 of bottle 14. Thereafter, blades 34 cut into the top sealing surface 22 to produce scores, or scorelines 94 and provide a test specimen bottle for evaluating the integrity of the seal of a closure; such as, for example, those test as described in U.S. Pat. No. 6,526,810 to Konieczki and U.S. Pat. No. 6,807,846 to Leonard, the disclosures of which are herein incorporated by reference.

In order to produce control bottles 14 which have consistent level of deformation, the downward movement of scoring head 16 is limited to a predetermined distance so that it is stopped at the same point when deforming each bottle. This results in producing a consistent depth for scores 94. Since the closures are tested with like deformed bottles, consistent and meaningful results can be obtained in seal integrity tests. Typically, a relatively shallow depth may be used. Those skilled in the art will appreciate that the actual depth selected will depend on the level of deformation which simulates a sealing surface quality which is at the low end of the quality tolerance of a bottle for a given type of bottle. Another way to produce bottles 14 with consistent deformations is to apply the same deforming force using press 20 whenever producing the scores 94 of bottle 14. An appropriate deforming force can include a force within a range from 30 to 70 pounds, for example, 50 pounds.

It is noted that the use of support 12, wherein the clearance between plate 78 and base 76 leaves bottle bottom 58 unsupported, ensures that the deforming forces of head 16 are absorbed along the rigid neck 60 area of bottle 14. Thus, the force of scoring head 16 does act upon the thinner wall sidewall 56 portion of bottle 14. This prevents fractures and leaks from forming in the thinner sidewall 56 during the scoring of top sealing surface 22 of rim 70. If a small leak or rupture occurs in sidewall 56 which is not visible to the naked eye, such leaks can cause the later testing of the closure to indicate a closure failure when, in fact, no failure of closure seal 66 has taken place, but rather a failure of bottle sidewall 56 has occurred.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. An apparatus for use in the production of a test specimen from a container, said container for containing a liquid and having a sealing surface for mating with a sealing closure, said test specimen for utilization in a test evaluating the integrity of said sealing closure, the apparatus comprising:
a scoring head for scoring the sealing surface of a bottle, said scoring head including a body and at least one blade mounted to said body; and
a mounting structure associated with said body for connecting said body to a force applying mechanism for transmitting force to said body, whereby when said blade mounted to said body is positioned in axial alignment with said container adjacent to said sealing surface of said container, a force can be applied to said body to cause said blade to score said sealing surface to thereby produce from said container a container test specimen with a predetermined deformation of said sealing surface.

2. The apparatus of claim 1, wherein said apparatus includes a support for supporting said container.

3. The apparatus of claim 1, wherein said body has a first side, and a plurality of said blades are mounted at said first side, said blades positioned so as to extend in radial direction from said first side.

4. The apparatus of claim 3, wherein said apparatus includes a plurality of wedge members mounted to said first side in a spaced relationship, each of said blades positioned between at least two of said wedge members to secure said blades to said body.

5. The apparatus of claim 4, wherein said body includes a second side, and said mounting structure includes a shaft secured to said body, said shaft projecting from said second side of said body.

6. The apparatus of claim 5, wherein said mounting structure includes a bore in said second side of said body and a portion of said shaft is secured within said bore.

7. The apparatus of claim 2, wherein said apparatus includes a force applying mechanism, said force applying mechanism including a ram, said ram operatively connected to said scoring head body.

8. The apparatus of claim 2, wherein said support includes a plate having a recess formed therein, and said container is supported on said plate adjacent said recess.

9. The apparatus of claim 8, wherein said apparatus is adaptable for forming said test specimen from said container, said container comprising a bottle having a bottom, a neck, a ring formed around said neck, a top rim defining an opening for said bottle, and wherein said sealing surface appears on said bottle rim, said support plate of said apparatus supporting said bottle at said ring with a gap between said bottle bottom and said support.

10. An apparatus for the production of a test control bottle from a plastic bottle having a sealing surface on said bottle, said sealing surface adaptable for mating with a sealing closure to seal to the interior of said bottle, said test control bottle requiring said sealing surface to be deformed with a predetermined deformation to thereby produce a test specimen control bottle for use in a test for the evaluation of the integrity of the seal provided by said closure when said closure is applied to said test control bottle and subjected to a seal integrity test, said apparatus comprising:
a scoring head, said scoring head having a body and at least one blade mounted to said body, said body having a mounting surface for mounting said body to a force transmitting mechanism for applying a force to said body to cause said at least one blade to deform a container positioned adjacent said at least one blade to produce said test control bottle.

11. The apparatus of claim 10, wherein said body includes a first side, and said first side includes a plurality of said blades and a plurality of blade mounting members, said blade mounting members being removably mounted on said first side of said body in a spaced relationship to provide a plurality of spaces between said blade mounting members, said blades positioned in said spaces with said blade mounting members contacting said blades to secure said blades in place on said body.

12. The apparatus of claim 11, wherein said body has a second side opposite said first side, and said mounting surface appears in said second side and includes a bore in said second side, said apparatus including a shaft, said shaft mounted in said bore and projecting outwardly from said second side, said shaft adaptable for connecting to said force transmitting mechanism.

13. The apparatus of claim 10, wherein said body is generally circular in shape and said apparatus includes a plurality of wedge shaped members mounted about said first side in a spaced relationship and providing a plurality of spaces between said wedge shape members, said apparatus having a plurality of blades secured to said body by said wedge shaped members.

14. The apparatus of claim 10, wherein said apparatus includes a support for supporting and holding said plastic bottle during said deformation of said bottle.

15. The apparatus of claim 14, wherein said force transmitting mechanism includes a ram, said ram connected to said shaft, said ram reciprocally movable by said force transmitting mechanism to move said scoring head towards said support into an operative relationship with said plastic bottle held at said support, whereby said blades of said scoring head contact said sealing surface of said bottle to provide a plurality of scores on said sealing surface to produce said test control bottle, said force transmitting mechanism reciprocally moving said scoring head away from said test control bottle after scoring said bottle.

16. A method of producing test control bottles having a deformed sealing surface for later use in a quality control test of a closure mated to said deformed sealing surface, comprising:
providing a bottle with a sealing surface;
providing an apparatus which includes a scoring head, said scoring head having mounted thereon a plurality of blades;
positioning said bottle in operative alignment with said apparatus, causing relative movement between said scoring head and said bottle to cause said blades to contact said sealing surface; and
continuing said relative movement to continue to move said scoring head blades into said sealing surface to deform said sealing surface by scoring said sealing surface of said bottle to thereby produce a test control bottle.

17. The method of claim 16, wherein said continued relative movement is caused by a measured and repeatable force from a press, so that each of said provided bottles is deformed with approximately the same force to produce a test control bottle with approximately the same level of deformation at said sealing surface.

18. The method of claim 16, wherein said distance of said continued relative movement is repeatable for each of said provided bottles so that said sealing surfaces of said bottles are scored by said blades to approximately the same depth to produce test control bottles with scores of approximately the same depth in said sealing surface.

19. A test control bottle having a sealing surface, said test control bottle for utilization in a test for evaluating the integrity of a sealing closure, said test control bottle comprising:
an annular rim defining an opening to the interior of said bottle, a sealing surface on said rim, said sealing surface for mating with a bottle closure, said sealing surface having a predetermined deformation formed thereon including a plurality of scorelines, wherein said scorelines are radially positioned about said sealing surface.

20. The test control bottle of claim 19, wherein said scorelines are equally spaced about said sealing surface.
